(19) United States
(12) Patent Application Publication
(10) Pub. No.: US 2023/0104198 A1
(43) Pub. Date: Apr. 6, 2023

(54) POWER SAVING PDCCH MONITORING TECHNIQUES EQUIPMENT

(71) Applicant: Telefonaktiebolaget LM Ericsson (publ), Stockholm (SE)

(72) Inventors: Sina Maleki, MALMÖ (SE); Ali Nader, MALMÖ (SE); Andres Reial, HÖLLVIKEN (SE); Ilmiawan Shubhi, MALMÖ (SE)

(21) Appl. No.: 17/908,204

(22) PCT Filed: Mar. 12, 2020
(86) PCT No.: PCT/EP2020/056697

§ 371 Date: Aug. 30, 2022

(51) Int. Cl. H04W 76/28

(52) U.S. Cl. CPC H04W 76/28

(57) ABSTRACT

Power savings is achieved by configuring the UE with a sparse search space for power savings and a packed search space for normal PDCCH monitoring. The network is aware of the search space being monitored by the UE and can signal the UE to switch between the two search spaces by sending downlink control information (DCI) to the UE in the search space being monitored by the UE. To conserve power, the network switches the UE to the sparse search space for PDCCH monitoring, which requires less energy than PDCCH monitoring in the packed search space. When the network expects to have downlink data to send, the network sends downlink control information (DCI) to the UE in the sparse search space to cause the UE to switch to the packed search space. The DCI may comprise scheduling information, or a WUS-like signal indicating that the UE should switch search spaces for PDCCH monitoring.

### TECHNICAL FIELD

The present disclosure relates generally to downlink control channel monitoring and, more particularly, to power saving techniques for downlink control channel monitoring.

### BACKGROUND

One of the power-consuming activities of a connected mode user equipment (UE) is to monitor the Physical Downlink Control Channel (PDCCH). In this mode, the UE needs to perform blind detection in its configured control resource sets (CORESETs) to identify whether downlink control information (DCI) is sent to the UE on the PDCCH. On the other hand, the UE is not scheduled in most PDCCH monitoring occasions and thus, the PDCCH monitoring unnecessarily consumes energy when the UE is not scheduled to receive a downlink transmission.

In Release 15, discontinuous reception (DRX) is used to reduce energy consumption. In DRX mode, the UE will start an inactivity timer after a scheduling PDCCH is successfully decoded by the UE. Once the inactivity timer expires, the UE will go to sleep following a certain pattern of sleep and ON durations, the so-called DRX cycle. Using this DRX technique, the network will only transmit DCI scheduling the UE for a downlink transmission during the ON duration of the DRX cycle. Therefore, the UE only needs to monitor the PDCCH in those ON durations and can sleep between the ON durations in consecutive DRX cycles to save energy. Although DRX reduces energy consumption, DRX still requires the UE to wake-up quite frequently, especially when the length DRX cycle is relatively short. Also, the UE will waste a significant amount of energy when the ON duration is relatively long with respect to the duration of the DRX cycle.

In Release 16 (Rel-16) of the New Radio (NR) standard, the use of a wake-up signal (WUS) was introduced to further reduce UE power consumption. When a WUS is employed, the network sends a WUS to the UE before the start of the next ON duration of the DRX cycle if it expects to send DCI scheduling a downlink transmission to the UE. The UE's default behavior is to wake-up and monitor the PDCCH in the next ON duration of the DRX cycle only when a WUS is detected. If no WUS is detected during a WUS monitoring occasion, the UE remains in a sleep mode during the next ON duration. The WUS itself will be sent by the network when there is data in the buffer to be transmitted to the UE. By allowing the UE to conduct PDCCH monitoring only when there will be a transmission on the Physical Downlink Shared Channel (PDSCH), the UE energy consumption can be significantly reduced. In addition, WUS monitoring can be set to be more power-efficient compared to that of the normal PDCCH monitoring and thus, improves the UE energy efficiency even further.

The WUS approach as defined in Rel-16 provides attractive UE power saving gains by obviating the need for the UE to monitor ON durations when no data transmission to the UE is scheduled. However, the Rel-16 WUS mechanisms only apply to Rel 16 UEs or later and assumes that the deployed network implementation supports the Rel-16 WUS framework. Further, the WUS is only sent outside the active time of the DRX cycle. For Release-15 (Rel-15) UEs in any phase of operation, or in general any UE within the active time, currently there is no WUS mechanism to enable similar power saving gains.

### SUMMARY

The present disclosure relates to power saving techniques for PDCHH monitoring that is not dependent on the Rel-16 WUS framework. Power savings is achieved by configuring the UE with a sparse search space for power savings and a packed search space for normal PDCCH monitoring. The sparse search space contains fewer PDCCH resources than the packed search space and thus requires less energy to monitor. The network is aware of the search space being monitored by the UE and can signal the UE to switch between the two search spaces by sending downlink control information (DCI) to the UE in the search space being monitored by the UE. To conserve power, the network switches the UE to the sparse search space for PDCCH monitoring, which requires less energy than PDCCH monitoring in the packed search space. When the network expects to have downlink data to send, the network sends downlink control information (DCI) to the UE in the sparse search space to cause the UE to switch to the packed search space. The DCI may comprise scheduling information, or a WUS-like signal indicating that the UE should switch search spaces for PDCCH monitoring.

A first aspect of the disclosure comprises methods implemented by a UE of PDCCH monitoring. In one embodiment of the method, the UE configures a first search space for a PDCCH monitoring during an ON duration of a DRX cycle. The UE further configures a second search space for PDCCH monitoring during the ON duration of a DRX cycle. The second search space has a reduced amount of control channel resources compared to the first search space. The UE further receives DCI transmitted by a network node. Responsive to the DCI, the UE switches between the first search space and second search space as an active search space for PDCCH monitoring.

A second aspect of the disclosure comprises methods implemented by a network node of transmitting DCI to a UE as herein described. The network node (e.g., gNB) configures a UE with a first search space for PDCCH monitoring during an ON duration of a DRX cycle. The network node further configures the UE with a second search space for PDCCH monitoring during the ON duration of a DRX cycle, the second search space having a reduced amount of control channel resources compared to the first search space. The network node transmits DCI to the UE to switch the UE between the first search space and second search space as the active search space for PDCCH monitoring

A third aspect of the disclosure comprises a UE configured to perform the method according to the first aspect. In one embodiment, the UE comprises communication circuitry for communicating with a network node over a wireless communication channel and processing circuitry configured to perform the method according to the first aspect.

A fourth aspect of the disclosure comprises a network node (e.g., gNB) configured to perform the method according to the second aspect. In one embodiment, the network node comprises communication circuitry for communicating with a UE over a wireless communication channel and processing circuitry configured to perform the method according to the second aspect.

A fifth aspect of the disclosure comprises a computer program for a UE. The computer program comprises executable instructions that, when executed by processing circuitry in a UE in a wireless communication network, causes the UE to perform the method according to the first aspect.

A sixth aspect of the disclosure comprises a carrier containing a computer program according to the fifth aspect. The carrier is one of an electronic signal, optical signal, radio signal, or a non-transitory computer readable storage medium.

A seventh aspect of the disclosure comprises a computer program for a network node. The computer program comprises executable instructions that, when executed by processing circuitry in a network node in a wireless communication network, causes the network node to perform the method according to the second aspect.

An eighth aspect of the disclosure comprises a carrier containing a computer program according to the seventh aspect. The carrier is one of an electronic signal, optical signal, radio signal, or a non-transitory computer readable storage medium.

### BRIEF DESCRIPTION OF THE DRAWINGS

FIG. 1 illustrates an exemplary wireless communication network implementing the power saving PDCCH monitoring techniques as herein described.

FIG. 2 illustrates an exemplary time-frequency grid used by the wireless communication network.

FIG. 3 illustrates PDCCH monitoring during a discontinuous reception mode of operation.

FIG. 4 illustrates PDCCH monitoring in two search spaces in different bandwidth parts (BWPs).

FIG. 5 illustrates search space switching for PDCCH monitoring.

FIG. 6 illustrates an exemplary method implemented by a UE of PDCCH monitoring.

FIG. 7 illustrates an exemplary method implemented by a network node of transmitting DCI to a UE.

FIG. 8 illustrates an exemplary UE configured for PDCCH monitoring as herein described.

FIG. 9 illustrates an exemplary network node configured to transmit DCI to a UE as herein described.

FIG. 10 is a functional block diagram of an exemplary UE configured for PDCCH monitoring as herein described.

FIG. 11 is a functional block diagram of an exemplary network node configured to transmit DCI to a UE as herein described.

### DETAILED DESCRIPTION

Referring now to the drawings, an exemplary embodiment of the present disclosure will be described in the context of a Fifth Generation (5G) wireless communication network, also known as a New Radio (NR) communication network. The power saving techniques herein described can be easily adapted by those skilled in the art for use in communication networks based on other radio access technologies (RATs), such as Long Term Evolution (LTE) networks, Wideband Code Division Multiple Access (WCDMA) networks, Code Division Multiple Access (CDMA) 2000 networks, Wireless Fidelity (WiFi) networks, Worldwide Interoperability for Microwave Access (WiMAX) networks, Wireless Local Area Networks (LANs) (WLANs), Narrowband Internet of Things (NB-IoT) networks, or other wireless communication networks.

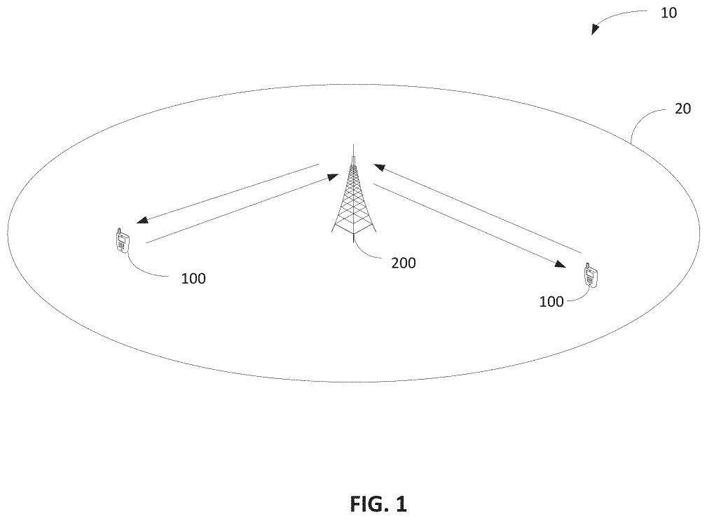

FIG. 1 illustrates a wireless communication network 10 comprising a base station 200 providing service to user equipment (UE) 100 in a cell 20 served by the base station 200. The base station 200 is sometimes referred to in applicable standards as an Evolved Node B (eNB), 5G Node B (gNB), or Next Generation eNodeB (ng-eNB). The UE 100, also referred to as a wireless device or wireless terminal, may comprise a cellular telephone, smart phone, laptop computer, notebook computer, tablet, machine-to-machine (M2M) communication devices (also referred to as machine-type communication (MTC) devices), or other devices with wireless communication capabilities. Although only a single cell 20 is shown, those skilled in the art will appreciate that a typical wireless communication network 10 can comprise many cells 20.

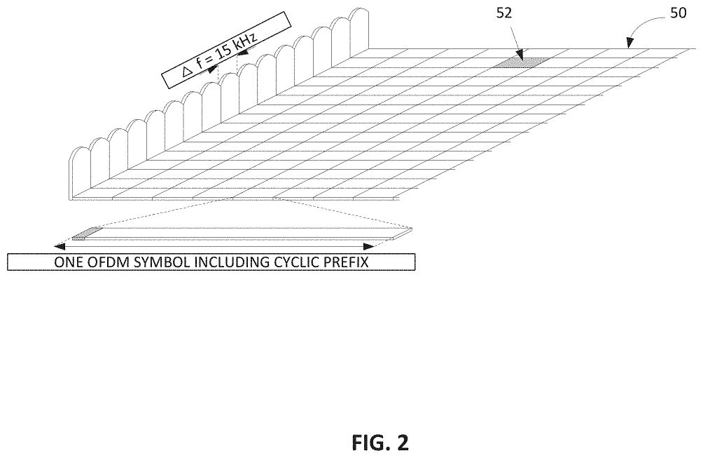

The radio resources in NR networks can be viewed as a time-frequency grid 50 as shown in FIG. 2. In the time domain, the physical resources are divided into subframes. Each subframe includes a number of symbols. For a normal Cyclic Prefix (CP) length, suitable for use in situations where multipath dispersion is not expected to be extremely severe, a subframe comprises fourteen symbols. A subframe comprises twelve symbols if an extended CP is used. In the frequency domain, the physical resources are divided into subcarriers. The number of subcarriers varies according to the allocated system bandwidth and numerology. A subframe typically comprises two time slots, which may be further subdivided into mini-slots. A mini-slot comprises one or more symbol periods in a time slot. The smallest element of the time-frequency grid 50 is a resource element (RE) 52, which comprises the intersection of one subcarrier and one symbol.

The base station 200 transmits information to the UE 100 on physical downlink (DL) channels. A physical DL channel corresponds to a set of REs carrying information originating from higher layers. The physical DL channels currently defined include the PDSCH, PDCCH and the Physical Downlink Broadcast Channel (PBCH). The PDSCH is the main physical channel used for unicast DL data transmission, but also for transmission of random access responses (RARs), certain system information blocks (SIBs), and paging information. The PDCCH is used for transmitting downlink control information (DCI), mainly scheduling decisions, required for reception of the PDSCH, and for uplink (UL) scheduling grants (SGs) enabling transmission on Physical Uplink Shared Channel (PUSCH). The PBCH carries the basic system information (SI) required by the UE 100 to access the network 10.

The base station 200 is responsible for scheduling DL transmissions to the UE 100 on the PDSCH and for allocating resources for the DL transmissions. The base station 200 sends DCI to the UE 100 on the PDCCH to schedule a DL transmission UE 100. The DCI includes scheduling information such as the allocated resources for the DL transmission and the modulation and coding scheme (MCS).

The UE 100 transmits information to the base station 200 on physical UL channels. A physical UL channel corresponds to a set of REs carrying information originating from higher layers. The physical UL channels currently defined include the PUSCH, the Physical Uplink Control Channel (PUCCH) and the Physical Random Access Channel (PRACH). The PUSCH is the UL counterpart to the PDSCH. The PUCCH is used by UEs 100 to transmit UL control information (UCI), including Hybrid Automatic Repeat Request (HARQ) acknowledgements, channel state information (CSI) reports, etc. The PRACH is used for random access preamble transmission.

The base station 200 is responsible for scheduling UL transmissions from the UE 100 and for allocating resources for the UL transmissions. After scheduling an UL transmission and allocating resources, the base station 200 sends a scheduling grant (SG) to the UE 100 indicating the resources on which the UE 100 has been scheduled and the transmission format for the scheduled transmission. The UL grant is sent to the UE 100 on the PDCCH. After receiving the UL, the UE 100 determines the UL transmit power for the transmission and transmits data to the base station 200 on the PUSCH resources indicated in the SG.

As noted above, the UE monitors the PDCCH to determine whether it has been scheduled to receive a DL transmission on the PDSCH. PDCCH monitoring consumes a significant amount of power and unnecessarily wastes energy if the UE is not being scheduled. Discontinuous reception (DRX) is a technique for conserving power in a UE 100. DRX allows UE 100 to transition to lower power state or “sleep mode” when it is not required to receive DL transmissions from the base station 200 and to wake-up periodically to monitor for paging messages and scheduling information.

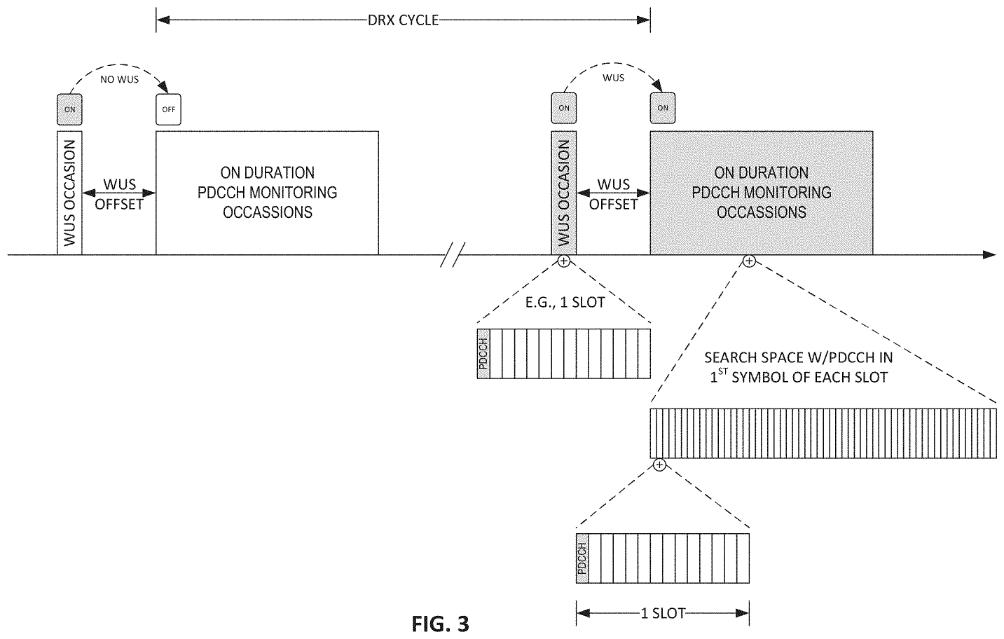

FIG. 3 illustrates DRX operation in simplified form. A DRX cycle is defined by a DRX period and an ON duration during which the UE 100 wakes-up and monitors the PDCCH for DCI addressed to the UE 100. If the UE 100 detects DCI addressed to the UE 100, the UE 100 starts an inactivity timer (IAT) and continues to monitor the PDCCH until the inactivity timer expires. The inactivity timer determines the number of consecutive PDCCH-subframe(s) or slots during which the UE 100 will remain awake after the subframe or slot in which the PDCCH indicates an initial UL, DL or sidelink (SL) data transmission for the UE 100. If the UE 100 receives DCI addressed to the UE 100, it extends or resets the inactivity timer and continues to monitor the PDCCH. When the inactivity timer expires, the UE 100 has the opportunity to sleep until the beginning of the next ON duration. In one embodiment the UE 100 stops receiving transmissions from base station 200 (e.g., no control monitoring) when the inactivity timer expires and goes to sleep until beginning of the next DRX cycle. The ON duration and the time duration during which the inactivity timer is running is generally referred to as active time.

DRX functionality is typically configured by Radio Resource Control (RRC), which operates on a slower time scale than the Medium Access Control (MAC) layer or physical layer. Thus, the DRX parameter settings cannot be changed as fast through RRC

While DRX reduces power consumption of the UE 100, the UE 100 still needs to wake-up quite frequently, especially when the DRX cycle length is relatively short. Also, the UE 100 can waste a significant amount of power when the ON duration is relatively long with respect to the duration of the DRX cycle

To further reduce power consumption when downlink transmissions to the UE 100 are infrequent, the network can send a WUS to the UE 1000 before the start of the ON duration as shown in FIG. 3. The UE 100 can be configured to wake-up to monitor for the WUS during a WUS monitoring occasion. If a WUS is detected, the UE 100 wakes-up on the next ON duration of the DRX cycle to monitor the PDCCH. The UE 100 can enter a microsleep state in the gap between the WUS monitoring occasion and the start of the next ON duration, or can remain awake. If no WUS is detected during the WUS monitoring occasion, the UE 100 returns to a sleep mode and sleeps through the next ON duration of the DRX cycle.

The WUS functionality is available only for Rel-16 UEs and only when the WUS framework is implemented by the network deployment. Therefore, there is still a need for power saving techniques that are not dependent on the implementation of the Rel-16 WUS.

According to one aspect of the present disclosure, power savings is achieved by configuring the UE 100 with two or more different PDCCH monitoring configurations including a “normal” PDCCH monitoring configuration and one or more power saving PDCCH monitoring configurations. A search space is defined for each PDCCH monitoring configuration. The power saving PDCCH monitoring configuration includes a sparse search space with fewer monitoring occasions for power savings. The normal PDCCH monitoring configuration uses a more packed search space compared to the power saving PDCCH monitoring configuration. Alternatively, the sparse search spaces may have PDCCH monitoring occasions with a shorter duration than the search space for normal PDCCH monitoring. Thus, the terms “sparse search space” and “packed search space” as used herein are relative terms used to indicate the relative amount of PDCCH resources in each search space. The sparse search space contains fewer PDCCH resources than the packed search space and thus requires less energy to monitor.

The network is aware of the current PDCCH monitoring configuration/search space used by the UE 100 for PDCCH monitoring and can signal the UE 100 to change the active PDCCH monitoring configuration/search space. As used herein, the active search space refers to the search space currently used by the UE 100 for PDCCH monitoring. Switching the PDCCH monitoring configuration enables the network to switch the UE 100 between a power saving configuration with fewer/shorter PDCCH monitoring occasion and a normal PDCCH configuration with more/longer PDCCH monitoring occasions. To conserve power, the network switches the UE 100 to the sparse search space for PDCCH monitoring, which requires less energy than PDCCH monitoring in the packed search space. When the network expects to have downlink data to send, the network sends downlink control information (DCI) to the UE 100 in the sparse search space to cause the UE 100 to switch to the packed search space. The DCI may comprise scheduling information, or a WUS-like signal indicating that the UE 100 should switch search spaces for PDCCH monitoring. Thus, the present disclosure provides a power saving mechanism that emulates Rel-16 WUS behavior.

Configuring Search Spaces for PDCCH Monitoring

As noted above, the UE 100 is configured to wake during each PDCCH monitoring occasion to check for any scheduled downlink transmission to the UE 100. Generally, the sparse search space is configured with a longer periodicity than the packed search space and fewer monitoring occasions. In one embodiment, the sparse search space is configured with a periodicity longer than the ON duration of the DRX cycle or with a periodicity longer than the inactivity timer (IAT) so that the sparse search space provides one PDCCH monitoring occasions in each DRX cycle. For example, the sparse search space can be configured with a periodicity equal to T/X, where T it he DRX cycle length and X is an integer. In other embodiments, the sparse search space may be configured to provide two or more PDCCH monitoring occasions in during a current ON duration or active time of the DRX cycle. The packed search space will typically provide multiple monitoring occasions during an ON duration or active time of a DRX cycle. In one embodiment, the packed search space is configured to provide one PDCCH monitoring occasion per time slot during the ON duration or active time of the DRX cycle.

In cases where the network 10 can activate/deactivate certain PDCCH monitoring configurations/search spaces either explicitly (e.g., using a DCI) or implicitly (e.g., upon reception of a scheduling DCI, expiration of a certain timer, etc.), the network 10 may decide to configure both sparse search spaces (the ones with comparable or longer than ON duration periodicity), and packed search spaces (the ones mainly intended for scheduling data) in the same Bandwidth Parts (BWP), e.g. in the Radio Resource Control (RRC) configuration. If the switching capability does not exist, or is not preferred, in the deployed network configuration, the network 10 may configure the sparse search spaces in separate BWPs from the ones with packed search spaces. Furthermore, the network 10 may decide to configure sparse search spaces in narrower BWPs with respect to the BWPs where the packed search spaces are configured, or vice versa.

For reasons of robustness, the network 10 may decide to associate different search spaces with different control resource sets (CORESETS), which may be associated with different Transmission Configuration Indicator (TCI) states to enhance the robustness of DCI reception in the sparse search space with regard to different beams. The network 10 may also apply higher aggregation levels for DCI transmitted in the sparse search space compared to the packed search space. The network 10 may also configure additional search spaces either using a search space duration parameter, or configure a number of search spaces in consecutive time slots of the PDCCH monitoring occasion to enable multiple PDCCH monitoring occasions.

In some embodiments, the network 10 may decide to configure a sparse search space for a secondary cell (SCell) or a group of SCells, either independently or in conjunction with the primary cell (PCell). In one embodiment, the network 10 configures the UE 100 such that the PDCCH monitoring occasions related to SCell are monitored in the PCell (so called cross-carrier scheduling). This cross-carrier PDCCH monitoring can save additional power by activating the SCell only when there is data to send. If nothing is scheduled in sparse search space, the UE 100 can sleep longer. In some embodiments, the network 10 configures the UE 100 to monitor the PDCCH for the SCell in cross-carrier mode, and upon data being scheduled, the packed search space is monitored in the SCell.

Considerations for Configuring Sparse Search Space

When the UE traffic is low, the network 10 may configure the UE 100 with a sparse search space for PDCCH monitoring to provide the UE 100 with a power saving option. For example, the network 10 may decide to configure the power saving PDCCH search space based on an amount of data traffic 9 i.e., traffic is less than a threshold) and/or when the data traffic is infrequent. In one example, the network 10 may note that a certain number of DRX ON durations may pass without data being scheduled, or that a significant part of IAT goes by without data being scheduled. In these scenarios, power savings can be achieved by allowing the UE 100 to switch to a sparse search space. The network 10 may also decide to configure a sparse search space for PDCCH monitoring if the UE 100 is not expected to receive critical information with low latency requirement.

Furthermore, the network 10 may decide to configure a sparse search space for PDCCH monitoring if the UE 100 indicates the need for power savings. For example, the UE 100 may indicate that it is in critical power situation through a form of UE 100 assistance information, or indicate to the network 10 that it can accept higher latency. One example of such an indication already available in Rel-15 is the Power Preference Indication (PPI) to a base station 200 in an LTE RAN. The LTE base station 200 could pass on this information to a base station 200 in a 5G RAN in a dual connectivity mode. As another example, the Overheating Assistance Indication (OAI) could be used as an input to the network's decision to configure a sparse search space. The UE 100 may also indicate a preference for a sparse search space. This can be in form of a simple preference indication, or with more detail, e.g., the desired search space/CORESET configuration per BWP, or in the same BWP, etc.

As mentioned above, the network 10 may decide to configure a sparse search space for both PCell and one or more SCells, or for SCells but not for PCell, or vice versa. The criterion for a separate configuration on SCells may be that the SCells are operated in a frequency range with significantly higher energy consumption due to radio frequency (RF) considerations and shorter slot length. In one embodiment, the UE 100 may be configured without a sparse search space (or a sparse search space with longer duration) on PCell in order to provide scheduling flexibility, and a sparse search space with a shorter duration in one or more SCells to allow scheduling on a SCell with minimal PDCCH monitoring effort for the UE 100.

In determining the location of monitoring occasions in the sparse search space, the network 10 can consider the number of the UEs 100 currently being served to make sure that the search space for each UE 100 can be spread across one ON duration without colliding. In addition, the network 10 can consider the slot location of a periodic measurement that should be conducted by the UE 100, i.e., to place the monitoring occasion as near as possible to the periodic measurement slot so that the UE 100 can gain more power saving.

The present disclosure achieves a WUS-like behavior by appropriate configuration of different search spaces for the UE 100. It should be noted that the monitoring occasions for the sparse search space is not limited to occur at the beginning of an ON duration. The network 10 may configure multiple monitoring occasions in the sparse search space are arbitrary locations with respect to the start of the ON duration, or multiple monitoring occasions during an ON duration whose length is extended (e.g. 50-100 ms), compared to conventional ON duration length (8-10 ms). This increases scheduler flexibility and robustness of PDCCH monitoring in the sparse search space.

Network Operation

On the network side, the base station 200 or other network node configures the UE with a normal PDCCH monitoring configuration and a power saving PDCCH monitoring configuration. In general, the power saving PDCCH monitoring configuration defines a search space with fewer control channel resources than the search space for normal PDCCH monitoring. The base station 200 or other network node can send DCI to the UE to switch the UE between the normal PDCCH monitoring configuration with a relatively packed search space and the power saving PDCCH monitoring configuration with a relatively sparse search space.

When the UE 100 has been configured with a sparse search space, the network 10 may assume that the UE 100 monitors the sparse search space in the active BWP. Note that the UE 100 may be configured with a sparse search space in one or more BWPs. When the network 10 expects downlink data for the UE 100, the network 10 may send DCI to the UE 100 in the sparse search space to cause the UE 100 to change to the packed search space for PDCCH monitoring. For example, the network 10 may send DCI to the UE 100 at the beginning of the DRX ON duration if there is immediate data to be delivered. In other embodiments, the network 10 may send DCI to the UE 100 an any other time during the active time of the DRX cycle compatible with the sparse search space configuration. The network 10 may also send the DCI if it expects some data to be delivered to the UE 100 within the current active time. For example, the network 10 may note that there is data in the UE 100 DL buffer but no immediate PDSCH scheduling resources available. Also, based on historical information or requests of the UE 100, the network 10 may determine that some downlink data is expected to arrive in the downlink buffer during the active time of the DRX cycle.

In embodiments where the UE 100 is configured with a sparse search space in both PCell and one or more SCells, the network 10 determines whether to switch the UE 100 from the sparse search space in both the PCell and one or more SCells, or just in a group of SCells, or other combinations thereof. The decision may depend on the scheduler strategy. For example, the base station 200 may prefer to schedule a given data burst on the PCell only or utilizing the PCell and one or more SCells. The latter option may be chosen when the base station 200 prioritizes emptying large buffer contents as quickly as possible, whereas the former may apply when the buffer contains small packets of bursty data.

The DCI to switch the UE 100 between different search space configurations may take a variety of forms. In some embodiments, the DCI can be specifically designed to move the UE 100 between different search space configurations, in the same or different BWP. For example, the DCI may comprise an explicit switch command or switch indication to cause the UE 100 to switch between search space configurations in the same or different BWPs. If the UE 100 is currently using the sparse search space as the active search space, the UE 100 switches to a packed search space and monitors the packed search space for scheduling information. If a downlink transmission is scheduled for the UE 100 on the PDSCH, the network 10 may send another switch command to the UE 100 at the end of the downlink data burst to switch the UE 100 back to the sparse search space if it does not expect any further downlink transmission to the UE 100 during the active time of the DRX cycle. Otherwise, the UE 100 may continue to use the packed search space as the active search space until it receives an indication from the network 10, or until a timer expires.

In some embodiments, the network 10 may send DCI scheduling a downlink transmission to the UE 100 in the sparse search space, which causes the UE 100 to switch search spaces. The DCI may include an additional bit field for a switch command or switch indication.

In some embodiments, the sparse search space and packed search space may be configured in different BWPS. In this case, the network 10 may send the UE 100 a scheduling DCI with a BWP change indication to cause the UE 100 to switch from the BWP with the sparse search space to the BWP with the packed search space. In some embodiments, the network 10 has the capability to signal the UE 100 to activate or deactivate certain search spaces either explicitly or implicitly.

If no actual data is scheduled by the DCI transmitted in the sparse search space, the DCI may contain dummy PDSCH information. Alternatively, the DCI may be used to schedule a CSI report, or similar mechanisms leading to a search space switch.

In cases where the UE 100 is configured with one or more SCells, the network 10 may either transmit the DCI directly in each SCell using mechanisms described above, or employ cross-carrier scheduling, or another type of cross-carrier DCI allowing the network 10 to indicate whether the UE 100 should change the PDCCH monitoring configurations in the SCells. Furthermore, depending on the configurations and possibilities, the network 10 may be able to configure the UE 100 the monitor the packed search space in the cross-carrier mode, or within the same carrier.

The search space configuration of a UE may also be a consideration in making scheduling decisions. When a UE 100 is monitoring a sparse search space, the network 10 has less flexibility to schedule the UE 100 when the UE 100 is in the sparse search space. In addition, when the network 10 does not schedule the UE 100 in an available monitoring occasion in the sparse search space, the impact to the delay is greater. Therefore, the network 10 could take into account the search space configuration of the UEs in making scheduling decisions. For example, the network could prioritize scheduling of UEs monitoring a sparse search space over UEs monitoring a more packed search space, or give greater weight to UEs in the sparse search space to bias the decision towards the UE 100 in the sparse search space.

When the UE 100 is configured with two or more search spaces, the network may need to take some measures to ensure that the UE 100 and base station 200 do not lose search space synchronization. When the network 10 schedules (or sends a signal to) a UE 100 monitoring the sparse search space, there is a possibility that the UE 100 will not detect the transmission. In this case, the network 10 and the UE 100 will be out of sync as the network 10 will assume that the UE 100 is monitoring a packed search space while it is actually monitoring the sparse mode. In this case, the UE 100 will not receive any downlink transmissions scheduled by the network 10. The network 10 may eventually discover the synchronization problem when the UE 100 fails to acknowledge the downlink transmission, but not before making one or more downlink transmissions to the UE 100. To minimize the wasted downlink transmissions, the network 10 can deliberately refrain from scheduling subsequent downlink transmission to the UE 100 for a certain period unless it receives an acknowledgement (ACK) from the UE 100 for the first or initial downlink transmission. Thus, the network 10 can schedule a first or initial downlink transmission to a UE 100 monitoring the sparse search space, and then continue scheduling in the packed search space after receiving an ACK from the UE 100 for the first PDSCH transmission.

The techniques herein described also addresses a potential drawback of WUS. When a WUS is used, a UE 100 will not wake during the ON duration of the DRX cycle unless a WUS is received. Because the UE 100 in this scenario does not wake during the active time of the DRX cycle, CSI measurement reporting is not performed. In the present disclosure, a power saving PDCCH monitoring occasion is provided during the On duration period of DRX cycle. Therefore, the network can request the UE 100 to provide a CSI report by sending the request during the PDCCH monitoring occasion.

UE Operation

The UE receives configuration information for PDCCH monitoring from the base station 200 or other network node. In exemplary embodiments herein described, the UE receives both a normal PDCCH monitoring configuration and a power saving PDCCH monitoring configuration. The UE configures a normal search space associated with the normal PDCCH monitoring configuration and a relatively sparse search space compared to the normal search space associated with the power saving PDCCH monitoring configuration. In general, the power saving PDCCH monitoring configuration defines a search space with fewer control channel resources than the search space for normal PDCCH monitoring. When the UE 100 is configured with two or more search spaces or PDCCH monitoring configurations, the UE may receive DCI from the base station 200 and switch between the normal PDCCH monitoring configuration/search space and the power saving PDCCH monitoring configuration/search space responsive to the DCI from the base station 200.

When the power saving PDCCH configuration/search space is active, the UE 100 may enter a power saving mode (e.g. light sleep or deep sleep) before each PDCCH monitoring occasion, and wakeup during the PDCCH monitoring occasion to monitor the sparse search space. Note that the PDCCH monitoring occasions in the sparse search space may be fewer than in the packed search space. If the UE 100 receives a DCI in the sparse search space indicating explicitly or implicitly that the UE 100 needs to switch to the packed search space, the UE 100 changes to the packed search space for PDCCH monitoring in either the same BWP or in a different BWP. When the UE 100 is configured with one or more SCells, the UE 100 should determine whether the search space switch applies to both PCell and SCells, or to a group of SCells, or some combination thereof, and apply the appropriate PDCCH monitoring configuration in those subsets.

If the UE 100 does not receive DCI during a PDCCH monitoring occasion, the UE 100 continues to use the sparse search space for PDCCH monitoring and can return to a low power mode (e.g., sleep mode) until the next PDCCH monitoring occasion. In some embodiments, the sparse search space may include more than one PDCCH monitoring occasion during the ON Duration or active time of the DRX cycle. In this case, the UE 100 should wait until the last PDCCH monitoring occasion in the current ON duration or active time of the DRX cycle before returning to the sleep mode. The UE 100 could, however, enter a light sleep or micro sleep mode between monitoring occasions in the same ON duration or active time of the DRX cycle. When the UE 100 determines that the next monitoring occasion is outside the current active time of the DRX cycle and the UE 100 BWP timer is expiring after that, the UE 100 can enter directly to a sleep mode until the next ON duration (e.g., enter a deeper sleep state as soon as possible). If some other configured activity is expected (e.g., a periodic CSI report, SRS transmission and so on), the UE 100 may wait until the configured activity is completed before returning to the sleep mode. Alternatively, if the next monitoring occasion is within the current ON duration or active time, but the time until the next monitoring occasion is sufficient for utilizing light or deep sleep modes, the UE 100 will transition temporarily to an appropriate (deepest feasible) sleep state between monitoring occasions. For example, if the available time is long enough, the UE 100 may decide to turn off the whole RX operation, but if it is not long enough, it only turns off part of the RX operation, e.g., the RF part.

Furthermore, in case the BWP timer expires before the next monitoring occasion and also before the end of the current active time, the UE 100 determines the appropriate power saving measure based on the PDCCH monitoring configuration in the default BWP or any other BWP that the UE 100 needs to change to after the BWP timer expires. In case the first PDCCH monitoring occasion in the next BWP comes before the next monitoring occasion in the current BWP, the UE 100 should be ready to receive DCI in the PDCCH monitoring occasion. In this case, the UE 100 may still able to apply a power saving measure between monitoring occasions. Nevertheless, in this case the UE 100 should not move directly to the DRX OFF duration, if the first PDCCH monitoring occasion in the next BWP falls before the end of the current active time.

Additionally, the UE 100 can note whether the DCI is received from the base station 200 in all or some of the SCells, and then apply the above mechanisms to save power in those SCells where the DCI is received. In this case, particularly if the UE 100 is configured with cross-carrier scheduling (at least for the sparse search space), and no data is scheduled for the SCell(s), the UE 100 may choose longer sleep durations as it does not have to wake up for the PDCCH monitoring occasion in the SCell(s).

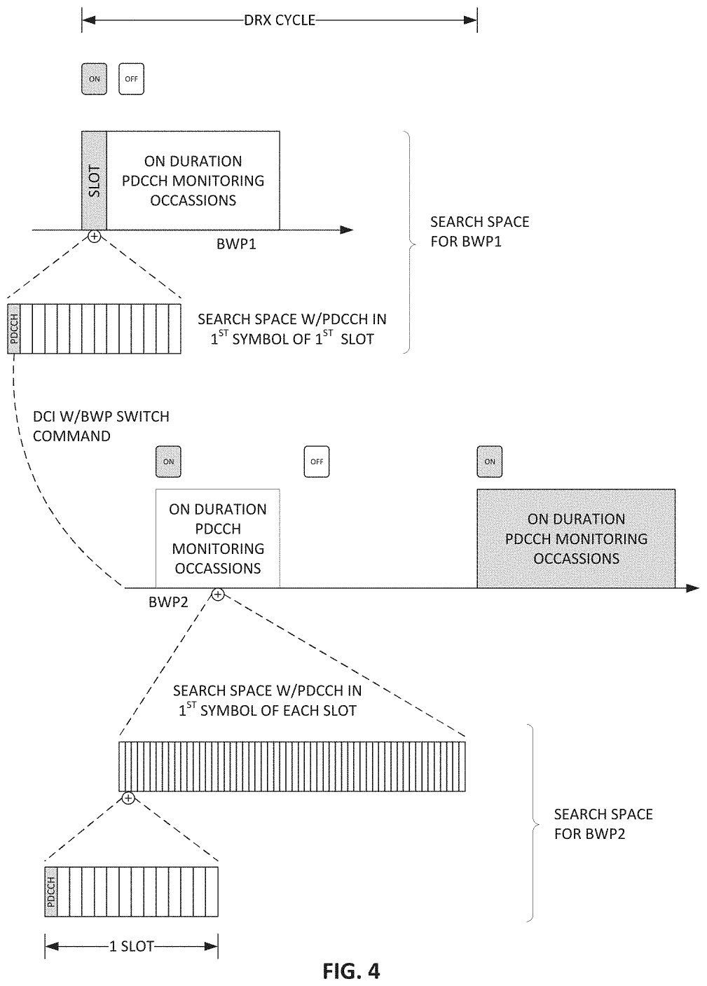

FIG. 4 illustrates an exemplary configuration of sparse and packed search spaces according to an embodiment. In FIG. 4, a sparse search space is configured in a first BWP and a packed search space is configured in a second BWP. The first BWP may be narrower than the second BWP. The UE 100 monitors the sparse search space when the first BWP is the active BWP and monitors the packed search space when the second BWP is the active BWP. Thus, changing the active BWP causes the UE 100 to change the active search space for PDCCH monitoring. In this example, the periodicity of the sparse search space provides a single PDCCH monitoring occasion at the beginning of the first time slot in the ON duration of the DRX cycle. Those skilled in the art will appreciate, however, that the monitoring occasion could be located elsewhere during the ON duration. The periodicity of the packed search space provide one monitoring occasion for each slot during the ON duration of the DRX cycle.

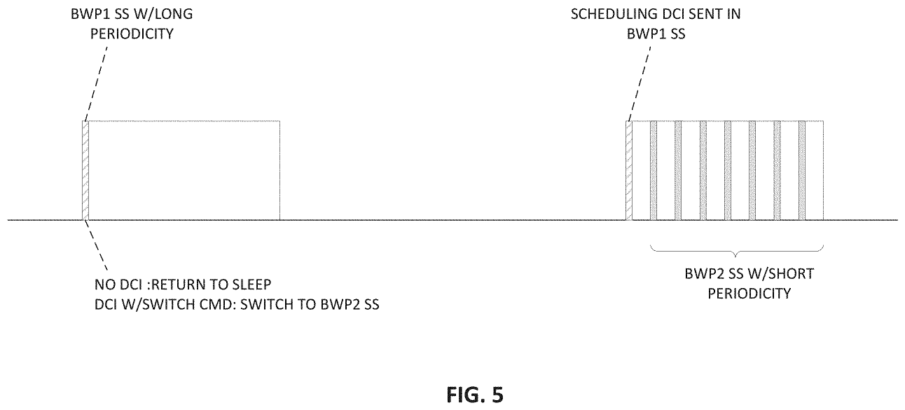

FIG. 5 illustrates search space switching in accordance with an embodiment. This example, assumes the search space configuration shown in FIG. 4. As shown in FIG. 5, the UE 100 monitors a sparse search space in a first BWP. During the first ON duration, the UE 100 wakes a monitors the PDCCH in the sparse search space. The UE 100 in this example does not detect DCI in the sparse search space and returns to a sleep mode. IN the second ON duration, the UE 100 wakes and monitors the PDCCH in the sparse search space. In this example, the UE 100 detects DCI in the sparse search space and switches to the packed search space in the second BWP to continue monitoring the PDCCH in the packed search space.

As noted above, the power saving techniques as herein described are provided as a means to emulate the Rel-16 WUS behavior, indicating whether the UE 100 should monitor for a scheduling PDCCH in a given ON duration. However, as briefly mentioned above, the approach may also be used to provide data indication during the IAT phase of active time. After the UE 100 has received a scheduling DCI, the IAT is started, during which the UE 100 traditionally monitors the PDCCH in a packed monitoring configuration. If the arrival of additional data during the IAT is not certain, such monitoring can lead to considerable energy consumption. According to another aspect of the disclosure, the sparse search can be applied during the time that the IAT is running if data transmission is not certain. Thus, the UE 100 can be configured with a packed search space for PDCCH monitoring during an ON duration of the DRX cycle and a sparse search space for PDCCH monitoring during the IAT period. Between monitoring occasions in the IAT period, the UE 100 may transition to micro-sleep.

In an example embodiment, at the end of a current data burst, the UE 100 is switched to the sparse search space, e.g. monitoring every 4th slot. If a new data burst arrives during the IAT and a scheduling DCI is received in one of those monitoring occasion, the UE 100 is switched to a packed search space for the duration of the data burst. At the end of the data burst, the UE 100 is switched back to the sparse search space.

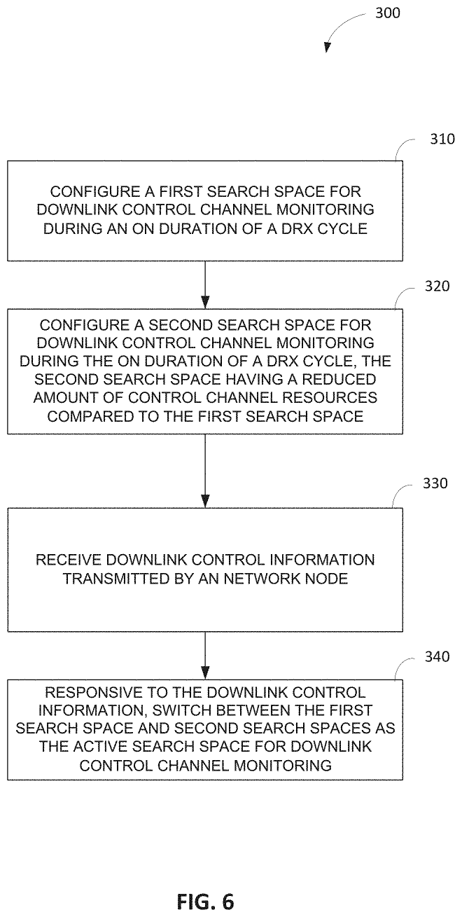

FIG. 6 illustrates an exemplary method 300 implemented by a UE 100 of PDCCH monitoring. The UE 100 configures a first search space for a PDCCH monitoring during an ON duration of a DRX cycle (block 310). The UE 100 further configures a second search space for PDCCH monitoring during the ON duration of a DRX cycle (block 320). The second search space has a reduced amount of control channel resources compared to the first search space. The UE 100 further receiving DCI transmitted by a network node (block 330). Responsive to the DCI, the UE 100 switches between the first search space and second search space as an active search space for PDCCH monitoring (block 340).

In some embodiments of the method 300, the DCI comprises a switch command. The switch command may be received in DCI transmitted to the UE 100 in the active search space.

In some embodiments of the method 300, the switch command is received by the UE 100 in DCI scheduling a downlink transmission transmitted to the UE 100 in the second search space, and the UE 100 switches to the first search space for PDCCH monitoring responsive to the switch command. In other embodiments of the method 300, the switch command is transmitted to the UE 100 in non-scheduling DCI.

In some embodiments of the method 300, the switch command is received by the UE 100 in DCI following the end of a downlink transmission, and the UE 100 switches to the second search space responsive to the switch command.

In some embodiments of the method 300, the DCI comprises scheduling information for a downlink transmission received by the UE 100 in the second search space, and the UE 100 switches to the first search space for PDCCH monitoring responsive to the switch command. In some embodiments, the network node switching back from the first search space to the second search space responsive to expiration of a timer.

In some embodiments of the method 300, a periodicity of the second search space is longer than a periodicity of the first search space and provides one or more monitoring occasions during an ON duration of a DRX cycle. As one example, the periodicity of the second search space is greater than an ON duration of the DRX cycle. As another example, the periodicity of the second search space is greater than a duration of an inactivity timer.

In some embodiments of the method 300, a periodicity of the second search space is shorter than an ON duration of the DRX cycle, and the second search space provides multiple monitoring occasions during the ON duration of the DRX cycle.

In some embodiments of the method 300, a time duration of a monitoring occasion in the second search space is less than a time duration of a monitoring occasion in the first search space.

In some embodiments of the method 300, the first and second search spaces are configured in first and second bandwidth parts (BWPs) respectively. In one example, the second BWP is narrower than the first BWP.

In some embodiments of the method 300, the first and second search spaces are associated with different control resource sets (CORESETS).

In some embodiments of the method 300, the control resources for the second search space is a subset of the control resources for the first search space.

In some embodiments of the method 300, configuring a second search space for PDCCH monitoring comprises configuring the second search space for a secondary cell (SCell) or group of SCells. In one embodiment of the method 300, PDCCH monitoring for the SCell is performed in an associated primary cell (PCell).

In some embodiments of the method 300, DCI received in the second search space has a higher aggregation level than DCI received in the first search space.

Some embodiments of the method 300 further comprise monitoring the PDCCH in the first search space during an ON duration of the DRX cycle, and switching to the second search space to monitor the PDCCH while the inactivity timer is running.

Some embodiments of the method 300 further comprise prioritizing scheduling of UEs monitoring the PDCCH in the second search space over UEs monitoring the PDCCH in the first search space.

Some embodiments of the method 300 further comprise transmitting DCI to a UE 100 in the second search space, scheduling a downlink transmission to the UE 100 on a downlink shared channel, and waiting for an acknowledgement of the scheduled downlink transmission before transmitting DCI to a UE 100 in the first search space, scheduling a downlink transmission to the UE 100 on the downlink shared channel.

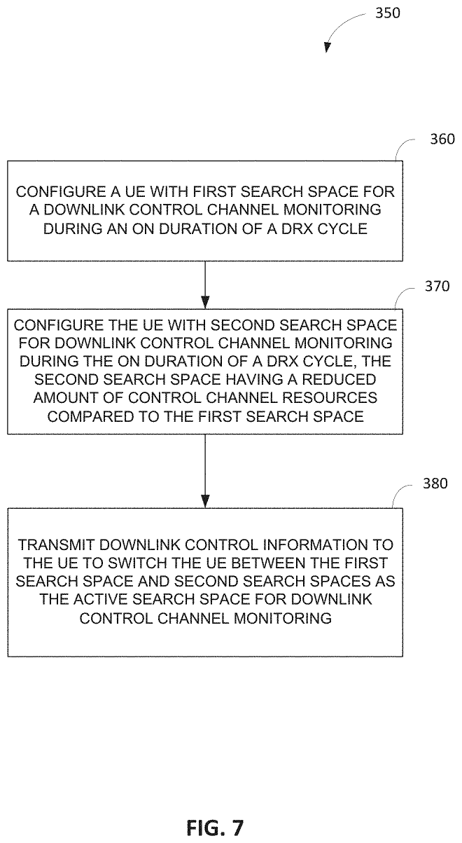

FIG. 7 illustrates an exemplary method 350 implemented by a network node of transmitting DCI to a UE 100 as herein described. The network node (e.g., gNB) configures a UE 100 with a first search space for PDCCH monitoring during an ON duration of a DRX cycle (block 360). The network node further configures the UE 100 with a second search space for PDCCH monitoring during the ON duration of a DRX cycle. The second search space having a reduced amount of control channel resources compared to the first search space (block 370). The network node transmits DCI to the UE 100 to switch the UE 100 between the first search space and second search space as the active search space for PDCCH monitoring (block 340).

In some embodiments of the method 350, the DCI comprises a switch command transmitted to the UE 100 in the active search space.

In some embodiments of the method 350, the switch command is transmitted to the UE 100 in DCI scheduling a downlink transmission transmitted to the UE 100 in the second search space, and the UE 100 switches to the first search space for PDCCH monitoring responsive to the switch command. In other embodiments of the method 350, the switch command is transmitted to the UE 100 in non-scheduling DCI.

In some embodiments of the method 350, the switch command is transmitted to the UE 100 in DCI following the end of a downlink transmission, and the UE 100 switches to the second search space responsive to the switch command.

In some embodiments of the method 350, the DCI comprises scheduling information for a downlink transmission transmitted to the UE 100 in the second search space, and the UE 100 switches to the first search space for PDCCH monitoring responsive to the switch command. In some embodiments, the network node switching back from the first search space to the second search space responsive to expiration of a timer.

In some embodiments of the method 350, a periodicity of the second search space is longer than a periodicity of the first search space and provides one or more monitoring occasions during an ON duration of a DRX cycle. As one example, the periodicity of the second search space is greater than an ON duration of the DRX cycle. As another example, the periodicity of the second search space is greater than a duration of an inactivity timer.

In some embodiments of the method 350, a periodicity of the second search space is shorter than an ON duration of the DRX cycle, and the second search space provides multiple monitoring occasions during the ON duration of the DRX cycle.

In some embodiments of the method 350, a time duration of a monitoring occasion in the second search space is less than a time duration of a monitoring occasion in the first search space.

In some embodiments of the method 350, the first and second search spaces are configured in first and second bandwidth parts (BWPs) respectively. In one example, the second BWP is narrower than the first BWP.

In some embodiments of the method 350, the first and second search spaces are associated with different control resource sets (CORESETS).

In some embodiments of the method 350, the control resources for the second search space is a subset of the control resources for the first search space.

In some embodiments of the method 350, configuring a second search space for PDCCH monitoring comprises configuring the second search space for a secondary cell (SCell) or group of SCells. In some embodiments, the network node configures a second search space for downlink control channel monitoring based on energy requirements of a frequency range in which the SCell operates.

In one embodiment of the method 350, PDCCH monitoring for the SCell is performed in an associated primary cell (PCell).

In some embodiments of the method 350, DCI transmitted in the second search space has a higher aggregation level than DCI transmitted di the first search space.

Some embodiments of the method 350 further comprise transmitting DCI to the UE 100 in the first search space during an ON duration of the DRX cycle, and transmitting DCI to the UE 100 in the second search space when an inactivity timer is running.

Some embodiments of the method 350 further comprise prioritizing scheduling of UEs monitoring the PDCCH in the second search space over UEs monitoring the PDCCH in the first search space.

In some embodiments of the method 350, configuring the UE 100 with a second search space for downlink control channel monitoring is performed based on at least one of an amount of data traffic, a frequency of the data traffic, a latency requirement of expected data traffic, and an indication from the UE of a need for power savings.

Some embodiments of the method 350 further comprise transmitting DCI to a UE 100 in the second search space, scheduling a downlink transmission to the UE 100 on a downlink shared channel, and waiting for an acknowledgement of the scheduled downlink transmission before transmitting DCI to a UE 100 in the first search space, scheduling a downlink transmission to the UE 100 on the downlink shared channel.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

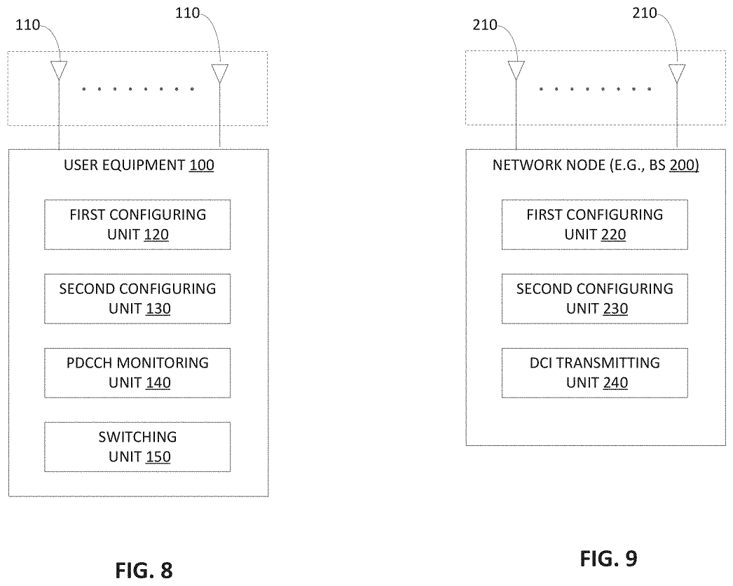

FIG. 8 illustrates a UE 100 in accordance with one or more embodiments. The UE 100 comprises one or more antennas 110, a first configuration unit 120, a second configuration unit 130, a PDCCH monitoring unit 140 and a switching unit 150. The various units 110-150 can be implemented by hardware circuits and/or by software code that is executed by one or more processors or processing circuits. The first configuration unit 120 configures a first search space for a PDCCH monitoring during an ON duration of a DRX cycle. The second configuration unit 130 configures a second search space for PDCCH monitoring during the ON duration of a DRX cycle. The second search space has a reduced amount of control channel resources compared to the first search space. The PDCCH monitoring unit 140 is configured to receive DCI transmitted by a network node. The switching unit 150 is configured to switch between the first search space and second search space as an active search space for PDCCH monitoring responsive to the DCI received from the network node.

FIG. 9 illustrates a base station 200 in accordance with one or more embodiments. The base station 200 comprises one or more antennas 210, a first configuration unit 220, a second configuration unit 230, and a DCI transmitting (TX) unit 240. The various units 220, 230 and 240 can be implemented by hardware circuits and/or by software code that is executed by a processor or processing circuit. The first configuration unit configures a UE with a first search space for PDCCH monitoring during an ON duration of a DRX cycle. The second configuration unit 230 configures the UE with a second search space for PDCCH monitoring during the ON duration of a DRX cycle. The second search space having a reduced amount of control channel resources compared to the first search space. The DCI transmitting unit 240 is configured to transmit DCI to the UE to switch the UE between the first search space and second search space as the active search space for PDCCH monitoring.

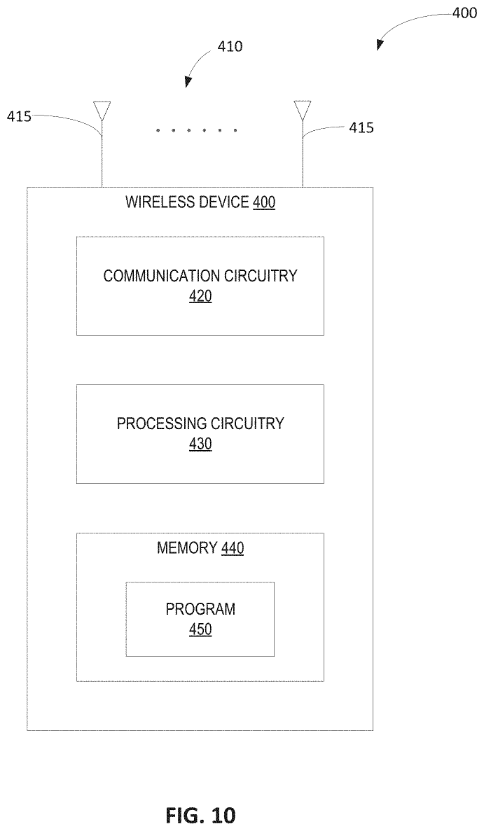

FIG. 10 illustrates an exemplary wireless device 400 (e.g. UE) configured to perform the method 300 according to FIG. 6. The wireless device 400 comprises an antenna array 410 comprising one or more antennas 415, communication circuitry 420, processing circuitry 430, and memory 440.

The communication circuitry 420 enables the wireless device 400 to communicate with an access node in the wireless communication network 10. The communication circuitry 420 incudes radio frequency (RF) circuitry needed for transmitting and receiving signals over a wireless communication channel. The RF circuitry may, for example, be configured to operate according to the 5G or NR standards.

The processing circuitry 430 controls the overall operation of the base station 18 400 and can be configured to perform the method 300 shown in FIG. 6. The processing circuitry 430 may comprise one or more microprocessors, hardware, firmware, or a combination thereof.

Memory 440 comprises both volatile and non-volatile memory for storing computer program code and data needed by the processing circuitry 430 for operation. Memory 440 may comprise any tangible, non-transitory computer-readable storage medium for storing data including electronic, magnetic, optical, electromagnetic, or semiconductor data storage. Memory 440 stores a computer program 450 comprising executable instructions that configure the processing circuitry 430 to implement the method 300 according to FIG. 6. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 450 for configuring the processing circuitry 430 as herein described may be stored in a removable memory, such as a portable compact disc, portable digital video disc, or other removable media. The computer program 450 may also be embodied in a carrier such as an electronic signal, optical signal, radio signal, or computer readable storage medium.

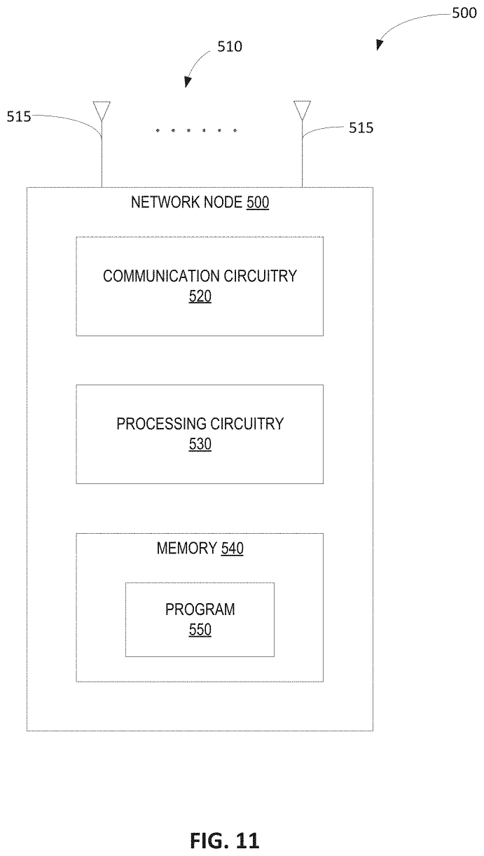

FIG. 11 illustrates an exemplary network node (e.g., gNB) 500 configured to perform the method 350 of FIG. 7. The network node 500 comprises an antenna array 510 comprising one or more antennas 515, a communication circuitry 520, a processing circuitry 530, and memory 540.

The communication circuitry 520 enables the network node 500 to communicate with UEs in the wireless communication network. The communication circuitry 520 incudes radio frequency (RF) circuitry needed for transmitting and receiving signals over a wireless communication channel. The RF circuitry may, for example, be configured to operate according to the 5G or NR standards. The communication circuitry 520 may further include network interface circuitry to enable the network node 500 to communicate with other network nodes over a communication network (e.g., backhaul or sidehaul)

The processing circuitry 530 controls the overall operation of the network node 500 and can be configured to perform the method 350 shown in FIG. 7. The processing circuitry 530 may comprise one or more microprocessors, hardware, firmware, or a combination thereof.

Memory 540 comprises both volatile and non-volatile memory for storing computer program code and data needed by the processing circuitry 530 for operation. Memory 540 may comprise any tangible, non-transitory computer-readable storage medium for storing data including electronic, magnetic, optical, electromagnetic, or semiconductor data storage. Memory 540 stores a computer program 550 comprising executable instructions that configure the processing circuitry 530 to implement the method 350 according to FIG. 7. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 550 for configuring the processing circuitry 530 as herein described may be stored in a removable memory, such as a portable compact disc, portable digital video disc, or other removable media. The computer program 550 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

The techniques herein described enable efficient UE wake up mechanisms before introduction of 3GPP Rel-16 WUS. For a Rel-15 UE, WUS-like behavior is enabled by having a sparse/single PDCCH monitoring occasion during a DRX ON duration and switching to a dense/multi PDCCH monitoring occasion via BWP switching when data is transmitted to the UE 100. The methods and apparatus as herein described enable NR wireless devices to achieve significant power savings during PDCCH monitoring that in turn leads to longer battery lifetime. The techniques as herein described can be implemented by Rel-15 compliant devices and/or in Rel-15 complaint networks that do not implement the WUS framework.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method of monitoring a downlink control channel implemented by a user equipment operating in a discontinuous reception (DRX) mode, the method comprising:
configuring a first search space for a downlink control channel monitoring during an ON duration of a DRX cycle;
configuring a second search space for downlink control channel monitoring during the ON duration of a DRX cycle, the second search space having a reduced amount of control channel resources compared to the first search space;
receiving downlink control information transmitted by a network node; and
responsive to the downlink control information, switching between the first search space and second search space as an active search space for downlink control channel monitoring.

2. The method of claim 1 wherein the downlink control information comprises a switch command received in DCI transmitted to the UE in the active search space.

3. The method of claim 2 wherein:
the switch command is received by the UE in downlink control information scheduling a downlink transmission transmitted to the UE in the second search space; and
the UE switches to the first search space for downlink control channel monitoring responsive to the switch command,
wherein a periodicity of the second search space is longer than a periodicity of the first search space and provides one or more monitoring occasions during an ON duration of a DRX cycle.

4. (canceled)

5. (canceled)

6. (canceled)

7. (canceled)

8. (canceled)

9. The method of claim 1 wherein the periodicity of the second search space is longer than an ON duration of the DRX cycle.

10. The method of claim 1 wherein the periodicity of the second search space is longer than a duration of an inactivity timer.

11. The method of claim 1 wherein:
a periodicity of the second search space is shorter than an ON duration of the DRX cycle; and
the second search space provides multiple monitoring occasions during the ON duration of the DRX cycle.

12. The method of claim 1 wherein a time duration of a monitoring occasion in the second search space is less than a time duration of a monitoring occasion in the first search space.

13. (canceled)

14. (canceled)

15. (canceled)

16. (canceled)

17. (canceled)

18. (canceled)

19. (canceled)

20. The method claim 1 further comprising:
monitoring the downlink control channel in the first search space during an ON duration of the DRX cycle; and
switching to the second search space to monitor the downlink control channel while the inactivity timer is running.

21. A method of transmitting downlink control information (DCI) implemented by a network node, the method comprising:
configuring a UE with a first search space for a downlink control channel monitoring during an ON duration of a DRX cycle;
configuring the UE with a second search space for downlink control channel monitoring during the ON duration of a DRX cycle, the second search space having a reduced amount of control channel resources compared to the first search space;
transmitting downlink control information to the UE, to switch the UE, between the first search space and second search space as the active search space for downlink control channel monitoring,
wherein a periodicity of the second search space is longer than a periodicity of the first search space and provides one or more monitoring occasions during an ON duration of a DRX cycle.

22. (canceled)

23. (canceled)

24. (canceled)

25. (canceled)

26. (canceled)

27. (canceled)

28. (canceled)

29. The method of claim 21 wherein the periodicity of the second search space is greater than an ON duration of the DRX cycle.

30. The method of claim 21 wherein the periodicity of the second search space is greater than a duration of an inactivity timer.

31. The method of claim 21 wherein:
a periodicity of the second search space is shorter than an ON duration of the DRX cycle; and
the second search space provides multiple monitoring occasions during the ON duration of the DRX cycle.

32. The method of claim 21 wherein a time duration of a monitoring occasion in the second search space is less than a time duration of a monitoring occasion in the first search space.

33. (canceled)

34. (canceled)

35. (canceled)

36. (canceled)

37. (canceled)

38. (canceled)

39. (canceled)

40. (canceled)

41. The method of claim 21 further comprising:
transmitting downlink control information to the UE in the first search space during an ON duration of the DRX cycle; and
transmitting downlink control information to the UE in the second search space when an inactivity timer is running.

42. (canceled)

43. (canceled)

44. (canceled)

45. A wireless device configured for downlink control channel monitoring in a discontinuous reception mode, the wireless device being configured to:
configure a first search space for a downlink control channel monitoring during an ON duration of a DRX cycle;
configure a second search space for downlink control channel monitoring during the ON duration of a DRX cycle, the second search space having a reduced amount of control channel resources compared to the first search space;
receive downlink control information transmitted by a network node; and
responsive to the downlink control information, switch between the first search space and second search space as an active search space for downlink control channel monitoring,
wherein a periodicity of the second search space is longer than a periodicity of the first search space and provides one or more monitoring occasions during an ON duration of a DRX cycle.

46. The wireless device according to claim 45 wherein
the downlink control information comprises a switch command received in DCI transmitted to the UE in the active search space,
the switch command is received by the UE in downlink control information scheduling a downlink transmission transmitted to the UE in the second search space,
the UE switches to the first search space for downlink control channel monitoring responsive to the switch command.

47. A wireless device configured for downlink control channel monitoring in a discontinuous reception mode, the wireless device comprising:
communication circuitry for communicating with a network node in a wireless communication network; and
processing circuitry configured to:
configure a first search space for a downlink control channel monitoring during an ON duration of a DRX cycle;
configure a second search space for downlink control channel monitoring during the ON duration of a DRX cycle, the second search space having a reduced amount of control channel resources compared to the first search space;
receive downlink control information transmitted by a network node; and
responsive to the downlink control information, switch between the first search space and second search space as an active search space for downlink control channel monitoring,
wherein a periodicity of the second search space is longer than a periodicity of the first search space and provides one or more monitoring occasions during an ON duration of a DRX cycle.

48. The wireless device according to claim 47 wherein
the downlink control information comprises a switch command received in DCI transmitted to the UE in the active search space,
the switch command is received by the UE in downlink control information scheduling a downlink transmission transmitted to the UE in the second search space,
the UE switches to the first search space for downlink control channel monitoring responsive to the switch command.

49. A computer program comprising executable instructions that, when executed by processing circuitry in a UE in a wireless communication network, causes the UE to perform the method of claim 1.

50. (canceled)

51. A network configured to transmit downlink control information to a UE, the network node being configured to:
configure the UE with a first search space for a downlink control channel monitoring during an ON duration of a DRX cycle;
configure the UE with a second search space for downlink control channel monitoring during the ON duration of a DRX cycle, the second search space having a reduced amount of control channel resources compared to the first search space;
transmit downlink control information to the UE to switch the UE between the first search space and second search space as the active search space for downlink control channel monitoring,
wherein a periodicity of the second search space is longer than a periodicity of the first search space and provides one or more monitoring occasions during an ON duration of a DRX cycle.

52. The wireless device according to claim 51 wherein:
a periodicity of the second search space is shorter than an ON duration of the DRX cycle; and
the second search space provides multiple monitoring occasions during the ON duration of the DRX cycle.

53. A network configured to transmit downlink control information to a UE, the network node comprising:
communication circuitry for communicating with a network node in a wireless communication network; and
processing circuitry configured to:
configure the UE with a first search space for a downlink control channel monitoring during an ON duration of a DRX cycle;
configure the UE with a second search space for downlink control channel monitoring during the ON duration of a DRX cycle, the second search space having a reduced amount of control channel resources compared to the first search space;
transmit downlink control information to the UE to switch the UE, between the first search space and second search space as the active search space for downlink control channel monitoring,
wherein a periodicity of the second search space is longer than a periodicity of the first search space and provides one or more monitoring occasions during an ON duration of a DRX cycle.

54. The wireless device according to claim 53 wherein:
a periodicity of the second search space is shorter than an ON duration of the DRX cycle; and
the second search space provides multiple monitoring occasions during the ON duration of the DRX cycle.

55. A computer program comprising executable instructions that, when executed by a processing circuit in a base station in a wireless communication network, causes the base station to perform any one of the methods of claim 21.

56. (canceled)
